(19) United States
(12) Patent Application Publication
(10) Pub. No.: US 2023/0407017 A1
(43) Pub. Date: Dec. 21, 2023

(54) TECHNIQUES FOR COVALENT BONDING OF CARBON NANOTUBES TO SUBSTRATES

(71) Applicant: University of Cincinnati, Cincinnati, OH (US)

(72) Inventors: Noe Alvarez, Cincinnati, OH (US); Chaminda Nawarathne, Cincinnati, OH (US); Abdul Hoque, Cincinnati, OH (US); Pankaj Gupta, Cincinnati, OH (US); Chethani Ruhunage, Cincinnati, OH (US)

(73) Assignee: University of Cincinnati, Cincinnati, OH (US)

(21) Appl. No.: 18/036,337

(22) PCT Filed: Nov. 11, 2021
(86) PCT No.: PCT/US2021/058965

§ 371 Date: May 10, 2023

Related U.S. Application Data
(60) Provisional application No. 63/112,339, filed on Nov. 11, 2020.
(60) Provisional application No. 63/225,190, filed on Jul. 23, 2021.

(51) Int. Cl. C08J 5/00; C09D 5/44

(52) U.S. Cl. CPC C08J 5/005; C09D 5/4476; B82Y 30/00

(57) ABSTRACT

The method of covalently bonding carbon nanotubes to substrates is provided. The method comprises functionalizing a substrate and each open-end of a plurality of open-ended carbon nanotubes, embedding each of the plurality of open-ended carbon nanotubes within respective polymers, aligning, orthogonally, the plurality of open-ended carbon nanotubes relative to the substrate, and applying pressure on each of the plurality of open-ended carbon nanotubes relative to the substrate for enabling covalent bonding of each of the plurality of open-ended carbon nanotubes to the substrate.

### CROSS REFERENCE TO RELATED APPLICATIONS

This application claims priority to U.S. Application Ser. No. 63/112,339 filed on Nov. 11, 2020 and U.S. Application Ser. No. 63/225,190 filed on Jul. 23, 2021, the entire disclosures of which are hereby incorporated by reference.

### TECHNICAL FIELD

The embodiments described herein generally relate to bonding carbon nanotubes to substrates, and more specifically, to vertically orienting carbon nanotubes relative to the substrates as part of the bonding process, in order to avoid the need for and reduce the adverse effects of high temperatures.

### BACKGROUND

Carbon nanotubes (“CNTs”) are known to possess electrical, chemical, and thermal properties which make the carbon nanotubes suitable for a variety of different applications. In such applications, one or more CNTs are synthesized directly on one or more substrates that may be formed of various substances such as, e.g., copper, aluminum, titanium, tantalum, and stainless steel. To ensure extended and defect free catalyst life for the CNTs, the synthesis or bonding process has traditionally involved treatment of these components at high temperatures and the use of oxides or oxide layers that serve as catalyst support and enable the reduction of adverse effects such as catalyst ripening, carbine formation, alloying, and coarsening, which may result from such high temperatures. While oxides or oxide layers partially mitigate the adverse effects of high temperatures, the use of such layers generates electrical resistance between the CNTs and the one or more substrates, which adversely impacts operational life of these components. Other synthesizing and interfacing approaches such as, e.g., self-assembly of monolayers, soldering, colloidal metallic pastes, and electrodeposition, etc., suffer from similar deficiencies.

Accordingly, a need exists for an interfacing technique that enables covalent bonding of CNTs to one or more substrates and does not suffer the adverse effects of high temperatures.

### SUMMARY

In one embodiment, a method for covalently bonding carbon nanotubes to substrates is provided. The method comprises functionalizing a substrate and each open-end of a plurality of open-ended carbon nanotubes, embedding each of the plurality of open-ended carbon nanotubes within respective polymers, aligning, orthogonally, the plurality of open-ended carbon nanotubes relative to the substrate, and applying pressure on each of the plurality of open-ended carbon nanotubes relative to the substrate for enabling covalent bonding of each of the plurality of open-ended carbon nanotubes to the substrate.

In another embodiment, a method for covalently bonding carbon nanotubes to substrates is provided. The method comprises functionalizing a substrate and each open end of a plurality of high density open-ended carbon nanotubes, embedding each of the plurality of high density open-ended carbon nanotubes within respective polymers, aligning, orthogonally, the plurality of high density open-ended carbon nanotubes relative to the substrate in a forest format, and applying pressure on each of the plurality of high density open-ended carbon nanotubes relative to the substrate for enabling covalent bonding of each of the plurality of high density open-ended carbon nanotubes to the substrate.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a flowchart for a method of covalently bonding an open-ended CNT to various structures, according to one or more embodiments described and illustrated herein.

FIG. 1B schematically depicts an example open-ended CNT that is bonded to two metal structures positioned on opposite ends of the open-ended CNT, according to one or more embodiments described and illustrated herein;

FIG. 1C schematically depicts an example open-ended CNT that is bonded to a metal structure and a polymer positioned on opposite ends of the open-ended CNT, according to one or more embodiments described and illustrated herein;

FIG. 1D schematically depicts an example open-ended CNT that is bonded to a metal structure and a polymer positioned on opposite ends of the open-ended CNT, according to one or more embodiments described and illustrated herein;

FIG. 1E depicts a mechanism for electrochemical inclusion of ethylenediamine functional group to a surface of a substrate, according to one or more embodiments described and illustrated herein;

FIG. 2A depicts an example of a process of fabrication of an open ended CNT that is covalently bonded to a metal substrate, according to one or more embodiments described and illustrated herein;

FIG. 2B depicts a magnified image of an example open-ended CNT, an encapsulation of the example open-ended CNT within an example polymer, and a cross-sectional view of an open-end of the example open ended CNT, according to one or more embodiments described and illustrated herein;

FIG. 3A depicts a graphical representation including a plurality of curves representative of FTIR spectral analysis associated with substrates formed of various materials, according to one or more embodiments described and illustrated herein;

FIG. 3B depicts an example graphical representation that is representative of FTIR spectral analysis of a pure 4-phenylenediamine, according to one or more embodiments described and illustrated herein;

FIG. 4 depicts an example graphical representation that is representative of a Raman spectrum of a copper substrate, according to one or embodiments described and illustrated herein;

FIG. 5 depicts a scanning electron microscope (SEM) image of an example open-ended CNT that is vertically or orthogonally oriented relative to an example substrate, according to one or more embodiments described and illustrated herein;

FIG. 6 depicts another SEM image that is representative of the interface between an example open-ended CNT and a substrate, according to one or more embodiments described and illustrated herein;

FIG. 7 depicts a plurality of three-dimensional SEM images representative of the covalent bonding of an example open-ended CNT with an example copper substrate, according to one or more embodiments described and illustrated herein;

FIG. 8 depicts an example graphical representation that is representative of a capability of a covalently bonded open-ended CNT to detect Pb²⁺, according to one or more embodiments described and illustrated herein;

FIG. 9 depicts an example graphical representation that is representative of electrical conductivity levels of an example open-ended CNT that is covalently bonded to a substrate, according to one or more embodiments described and illustrated herein;

FIG. 10 depicts an example graphical representation describing an electrochemical characterization of cyclic voltammograms of open-ended CNTs that are covalently bonded to one or more substrates, according to one or more embodiments described and illustrated herein; and

FIG. 11 depicts an example graphical representation illustrating cyclic voltammograms, according to one or more embodiments described and illustrated herein.

### DETAILED DESCRIPTION

As stated above, current CNT interfacing and synthesis techniques suffer from numerous deficiencies, e.g., catalyst ripening, carbine formation, alloying, and coarsening. While the use of oxide layers partially mitigates some of these deficiencies, the use of oxide layers has another deficiency—electrical resistance between the CNTs and one or more substrates with which the CNTs are bonded. The electrical resistance adversely affects the operational life of the CNTs and the substrates. The interfacing technique as described in the present disclosure addresses and overcome these deficiencies. Specifically, an interfacing technique or method for covalently bonding CNTs to one or more substrates is provided. The method includes functionalizing a substrate and each open-end of a plurality of open-ended carbon nanotubes, embedding each of the plurality of open-ended carbon nanotubes within respective polymers, aligning, orthogonally, the plurality of open-ended carbon nanotubes relative to the substrate, and applying pressure on each of the plurality of open-ended carbon nanotubes relative to the substrate for enabling covalent bonding of each of the plurality of open-ended carbon nanotubes to the substrate. Details regarding the implementation of this method will be described in detail later on in this disclosure.

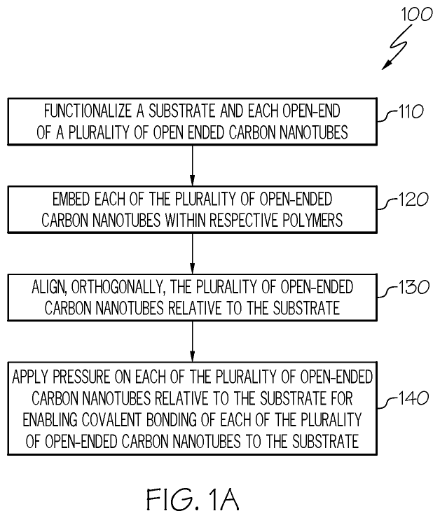

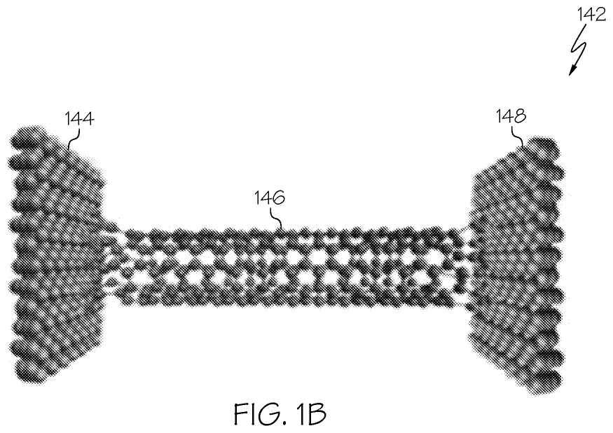

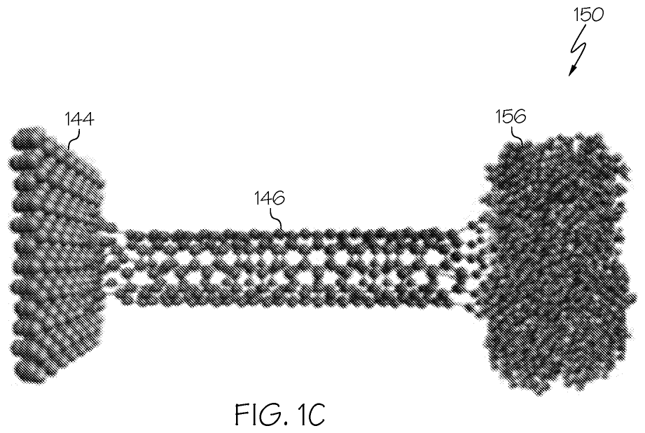

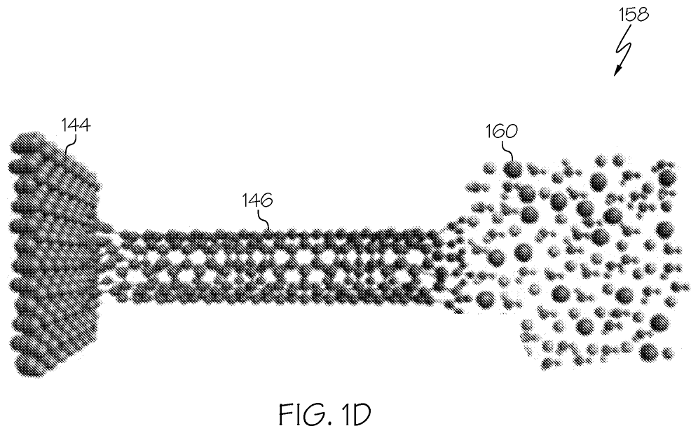

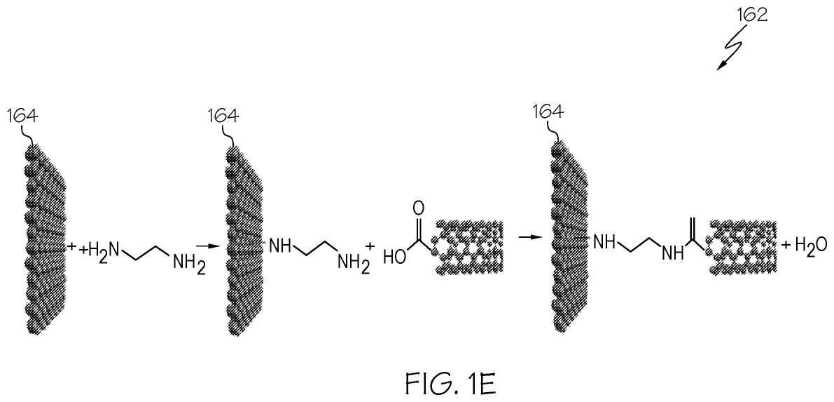

FIG. 1A depicts a flowchart 100 for a method of covalently bonding an open-ended CNT to various substrates, according to one or more embodiments described and illustrated herein.

At block 110, the method as relating to FIG. 1A includes the step of functionalizing a substrate and each open-end of a plurality of open-ended CNTs. Structurally, the plurality of open-ended CNTs may be a single array of CNTs, multiple arrays of CNTs, and so forth. In embodiments, each of the CNTs may be functionalized using a variety of processes such as, e.g., free radical addition, oxidation, carboxyl-based coupling, fluorination, and one or more addition and substitution reactions. It is noted that the functionalization may be performed to improve the manner in which each of the CNTs may be dispersed or adhered on the substrates. The substrates may be metals, polymers, or solutions of various types. Various techniques of functionalization are currently present, e.g., wet chemistry functionalization, but these techniques do not enable control of functional groups. The functionalization of the substrate and each open-end of a plurality of open-ended CNTs as described in the present disclosure addresses and overcome deficiencies and limitations of current techniques.

In particular, the functionalization as described in the present disclosure comprises microtoming the CNTs at each of their respective open ends. Microtoming, e.g., with the use of microtomed films, provide benefits to the covalently bonding process. In particular, microtoming enables a plurality of open-ended CNTs, each of which may have uniform dimensions, to be held in place according to a certain configuration, e.g., a cylindrical configuration. Such a configuration enables each open end to be exposed relative to objects (e.g., substrates) that are external to each of the CNTs. Additionally, another benefit is that microtoming covers the sidewalls of each of the open-ended CNTs from exposure. Microtoming also provides the benefit of limiting the width of the plurality of open-ended CNTs that are grouped together (e.g., an open-ended CNT array).

In other embodiments, the functionalization of the CNTs may be performed via electrografting, which includes applying a potential to each of the CNTs and one or more substrates in order to initiate the bonding process. Electrografting also involves an electrochemical reaction that enables organic layers, e.g., each open-end of each of the CNTs, to be coupled to the substrates. In embodiments, the electrografting may involve applying a voltage or electric potential to each of the plurality of open-ended CNTs in addition to the substrate in order to enable the covalent bonding process. It is noted that the covalent bonding may occur at a temperature in the range of 60 degrees to 250 degrees Celcius. In embodiments, the substrates (e.g., the first and second substrates described below and illustrated in FIGS. 1B-1D and other figures) may include or be formed from stainless steel, nickel, gold, polycrystalline copper, and other comparable materials, and may be functionalized using, e.g, aryl diazonium cations (R—N₂*).

It is noted that a variety of substances may be utilized to functionalize substrates that are formed of different materials. In embodiments, in order to covalently bond each open-end of each CNT and a substrate having a surface that is formed of copper or platinum, the surface of the substrate may be functionalized with amine groups. Amine group based functionalization may be initiated and performed using a spontaneous reaction between, e.g., p-aminobenzenediazonium cation and a copper substrate. It is noted that, in embodiments, each open-end of each of the plurality of CNTs may be treated with HNO₃ (nitric acid) and an example functionalization process utilized for treating the plurality of open-ended CNTs may be based on carboxylic functionalization. In embodiments, the functionalization may employ the use of highly reactive species (e.g., radical reactions) that are capable of bonding to the surfaces of substrates. As part of employing highly reactive species to implement the functionalization, a potential may be applied to each of the plurality of open-ended carbon nanotubes and the substrate for the enabling of the covalent bonding. It is additionally noted that, in embodiments, the functionalization of the substrates may be performed using electrically conducting organic molecules, e.g., molecular wires.

At block 120, as part of the covalent bonding of the open-ended CNTs to one or more substrates, each of the plurality of open-ended CNTs may be embedded within polymers. For example, the open-ended CNTs may be embedded within polymers such as polystyrene, epoxies, clear polymers, and so forth. After the embedding process, ultramicrotoming of the polymer embedded open-ended CNTs may be performed to ensure that the CNTs are encapsulated within, e.g., a 40 micrometer thin film. In embodiments, the thickness range of the thin film may be from approximately 7 micrometers to 500 micrometers.

At block 130, as part of the covalent bonding process of the present disclosure, each of the open-ended CNTs or the plurality of open-ended CNTs may be aligned orthogonally relative to one or more substrates. In embodiments, as illustrated in FIGS. 1B-1D, the plurality of CNTs may be positioned orthogonally or perpendicularly relative to one or substrates positioned adjacent to respective open ends of each of the open-ended CNTs.

At block 140, as part of the covalent bonding process of the present disclosure, in embodiments, pressure may be applied on the plurality of polymer-embedded open-ended CNTs to facilitate covalent bonding of the plurality of polymer-embedded open-ended CNTs to one or more substrates. In embodiments, the application of pressure may involve an application of a certain magnitude of voltage to the one or more substrates and the open-ended CNTs.

FIG. 1B schematically depicts an example open-ended CNT that is bonded to two metal structures positioned on opposite ends of the open-ended CNT, according to one or more embodiments described and illustrated herein. As illustrated in example CNT configuration 142, a first metal structure 144, a second metal structure 148, and an example open-ended CNT 146 may be bonded. In embodiments, the first and second metal structures 144, 148 may be formed of materials such as copper, aluminum, silver, titanium, tantalum, iridium, stainless steel, and so forth. The example open-ended CNT 146 may be defined as allotropes of carbon, made of graphite or a mix of graphite and carbon, and may have the shape of cylindrical tubes having a diameter in nanometers. CNTs have a high level of electric conductivity, thermal stability, chemical and environmental stability, low density, and high tensile strength. In embodiments, the example open-ended CNT 146 may be assembled through a spinning or drawing process. Additionally, the open-ended CNT may have a length of hundreds of micros, e.g., in a range of 450 micrometers to 480 micrometers, or even several millimeters, e.g., 2-4 millimeters.

As illustrated in FIG. 1B, the example open-ended CNT 146 is positioned such that it is vertically oriented relative to the first metal structure 144 and the second metal structure 148. In embodiments, the vertical orientation of the example open-ended CNT 146 may be such that the example open-ended CNT 146 is oriented normally relative to each of the first and second metal structures 144, 148 in a forest format. The process of covalent bonding of the example open-ended CNT 146 to each of the first and second metal structures 144, 148 is provided in FIG. 1D and illustrated in detail in various portions of this disclosure.

FIG. 1C schematically depicts an example open-ended carbon nanotube (“CNT”) that is bonded to a metal structure and a polymer positioned on opposite ends of the open-ended CNT, according to one or more embodiments described and illustrated herein. As illustrated in example CNT configuration 150, a first metal structure 144, an example polymer 156, and the example open-ended CNT 146. In embodiments, the polymer may be formed of Slygard™ or Unicryl™. It is noted that the polymers of Slygard™ and Unicryl™ are insulating polymers. Additionally, as previously stated, the first metal structure 144 may be formed of materials such as copper, aluminum, titanium, tantalum, stainless steel, and so forth.

FIG. 1D schematically depicts an example open-ended carbon nanotube (“CNT”) that is bonded to a meal structure and a polymer positioned on opposite ends of the open-ended CNT, according to one or more embodiments described and illustrated herein. As illustrated in the example CNT configuration 158, a first metal structure 144, an example open-ended CNT 146 and an example solution 160 are covalently bonded to each other. In embodiments, the solution as illustrated in FIG. 1C may be a commercially available solution such as, e.g., lead nitrate, nitric acid, and so forth.

FIG. 1E depicts a mechanism for electrochemical inclusion of ethylenediamine functional group to a surface of an example substrate 164, according to one or more embodiments described and illustrated herein. In particular, an organic compound in the form of ethylenediamine may be utilized to functionalize the surface of the substrate. In other embodiments, a compound in the form of p-phenylenediamine, which has a higher level of electric conductivity relative to ethylenediamine, may be utilized to functionalize the surface of the substrate. In embodiments, ethylenediamine may be electrochemically grafted on the example substrate 164 that is formed of platinum using acetonitrile (as a solvent) as part of a wet chemical process.

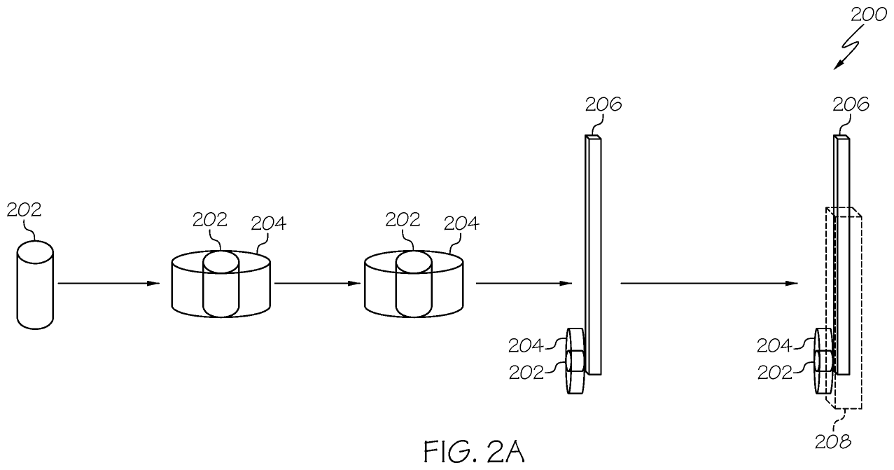

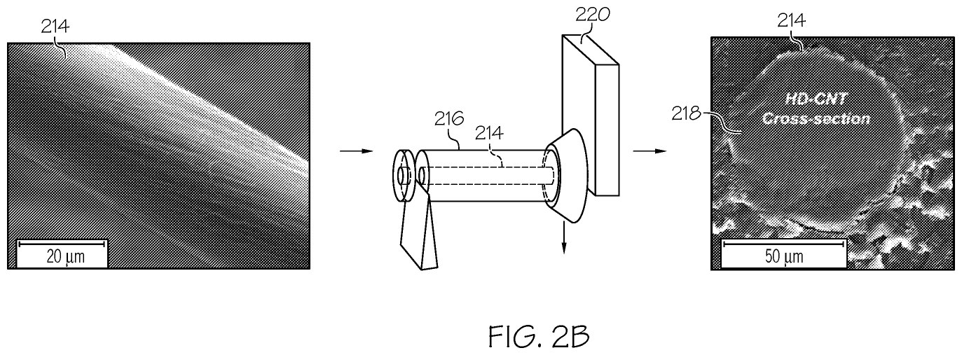

FIG. 2A depicts an example of a process of fabrication of an open ended CNT that is covalently bonded to a metal substrate, according to one or more embodiments described and illustrated herein. As illustrated, example open ended CNT 202 may be embedded within an example polymer 204 such as polystyrene, epoxies, clear polymers, and so forth, as described above. Thereafter, in embodiments, as described above, the example open ended CNT 202 embedded within the example polymer 204 may be oriented orthogonally relative to an example substrate 206 via an electrografting process as described above, which may involve applying a voltage or electric potential to each of the plurality of open-ended CNTs. The voltage may also be applied to the surface of the example substrate 206, e.g., a copper substrate. Additionally, in embodiments, an example epoxy 208 (e.g., an epoxy layer) may be applied to the example open ended CNT 202. In embodiments, the example epoxy 208 may serve as an insulating layer that limits the exposure of the example substrate (e.g., the copper substrate) to external elements, components, and so forth.

FIG. 2B depicts a magnified scanning electron microscope (“SEM”) image of an example open-ended CNT 214, an encapsulation of the example open-ended CNT 214 within an example polymer 216, and a cross-sectional view of an open-end of the example open ended CNT 214, according to one or more embodiments described and illustrated herein. As shown, a magnified view of the example open ended CNT 214 depicts a plurality of individual fibers of the CNT, which may have a diameter of 20 micrometers. It is noted that the individual fibers of the example open ended CNT 214 may be assembled based on a drawing or spinning process. Thereafter, the example polymer 216 may be embedded within an example polymer 216, e.g., polystyrene and epoxies, etc. Other examples of polymers may be a clear polymer such as Slygard™ or Unicryl™. Additionally, a cross sectional and top view 218 of the example open-ended CNT 214 is shown in FIG. 2B. As stated above, vertically or orthogonally aligning the example open-ended with the example substrate 220 and applying pressure to the open end of the example open-ended CNT 214 enables the generation of an robust and effective covalent bond between the example open-ended CNT 214 and the example substrate 220.

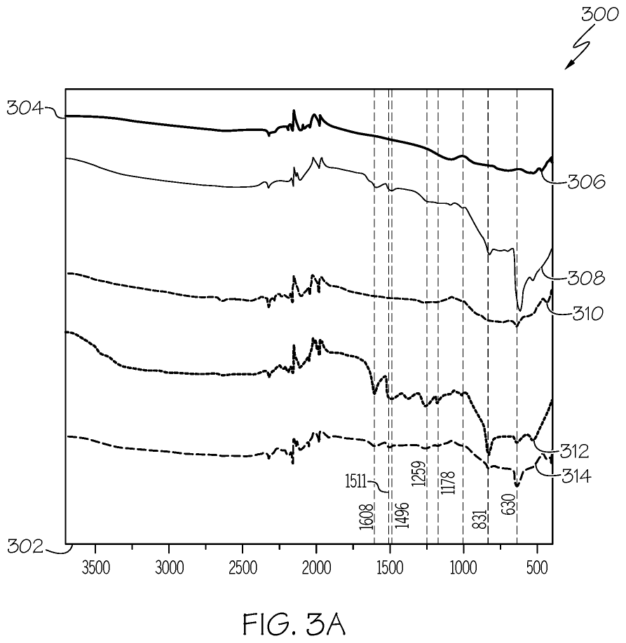

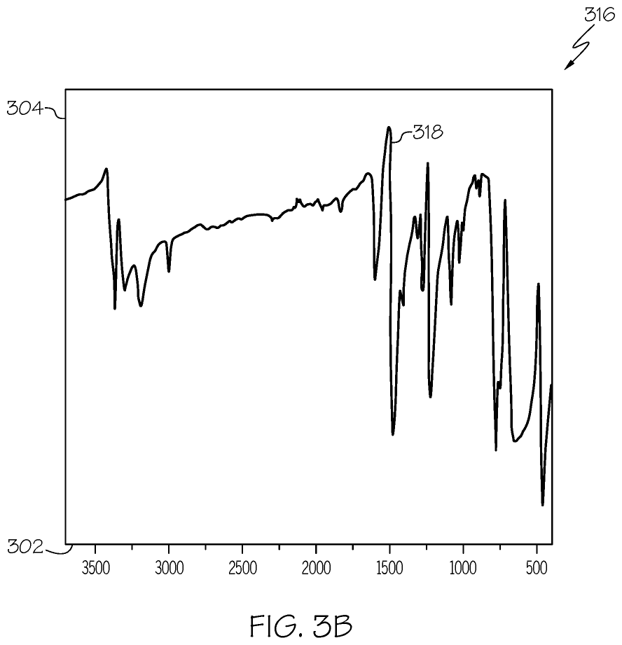

FIG. 3A depicts a graphical representation 300 including a plurality of curves representative of FTIR spectral analysis associated with substrates formed of various materials, according to one or more embodiments described and illustrated herein. The graphical representation 300 includes an x-axis 302 that is representative of wavelengths ranging from 4000 cm⁻¹ to 0 cm⁻¹, and a y-axis 304 that is representative of transmission percentages ranging from 0% to 100%. Data included in the graphical representation 300 may be analyzed to identify an efficiency level associated with the functionalization of an example substrate having a surface that is formed of polished copper. As shown, an example substrate formed of a copper surface may include a weak broad peak at approximately 3400 cm⁻¹.

In embodiments, the transmission level of the example substrate formed of polished copper peaked when the wavelength is approximately 4000 cm⁻¹ is high and reduces gradually as the wavelength gradually reduces from 4000 to 500 cm⁻¹, as indicated by example curve 306. Additionally, when the example substrate formed of copper is treated with aminophenyl at 25° C., as illustrated by an example curve 308, the transmission level of the example substrate peaks when the wavelength is around 2000 cm⁻¹ and gradually reduces as the wavelength approaches 500 cm⁻¹. Moreover, the largest transmission level of the copper substrate that is treated with aminophenyl at 25° C. is less than the untreated copper substrate having the polished copper surface. In other embodiments, when the example substrate formed of copper is treated with aminophenyl at 25° C. and sonicated, as illustrated by an example curve 310, the transmission level of the example substrate peaks when the wavelength is around 2000 cm⁻¹. The largest transmission level of the copper substrate that is treated with aminophenyl at 25° C. and sonicated is less than the untreated copper substrate having the polished copper surface.

In other embodiments, when the example substrate formed of copper is treated with aminophenyl at 65° C., as illustrated by an example curve 312, the largest transmission level of such a substrate is less than the untreated copper substrate and the copper substrate that is treated at 25° C. Additionally, when the example substrate formed of copper is treated with aminophenyl at 65° C. and sonicated, as illustrated by an example curve 312, the transmission level of the example substrate peaks when the wavelength is around 2000 cm⁻¹. The largest transmission levels for the substrate that is treated with aminophenyl at 65° C. and treated with aminophenyl at 25° C. and sonicated, respectively, are less than the peak transmission illustrated in example curves 306, 308, 310.

Additionally, it is noted that clear peaks may be observable in the wavelength range of 1350 to 1610 cm⁻¹, while may be attributed to C═C bond stretching, while the wavelength of 1259 cm⁻¹ may be attributed to C—NH₂, while 1178 cm⁻¹ may be attributed to CH bending. Additionally, the peak at 831 cm⁻¹ corresponds to a CH bending, and the wavelength at 630 cm⁻¹ corresponds to a ring deformation. As illustrated by the curves, peak intensities decrease as the reaction temperature decreases.

FIG. 3B depicts an example graphical representation 316 that is representative of FTIR spectral analysis of pure 4-phenylenediamine, according to one or more embodiments described and illustrated herein. As shown, the example curve 318 has a peak wavelength transmission level around 1500 cm⁻¹ and gradually decreases as the wavelength approaches 0 cm⁻¹.

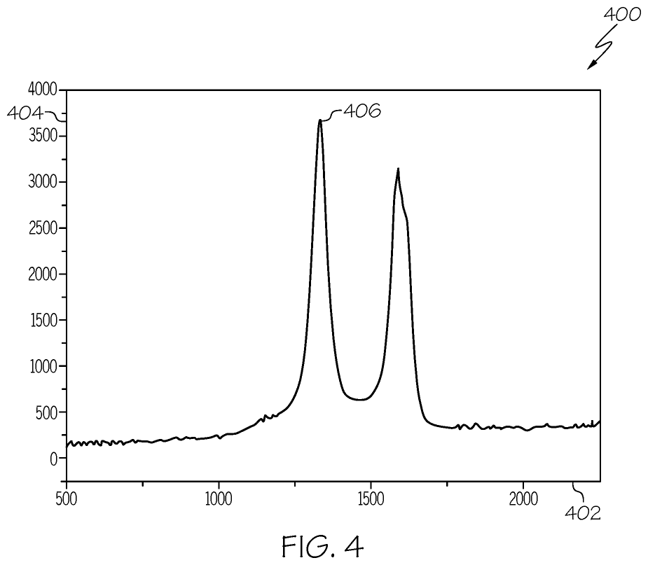

FIG. 4 depicts an example graphical representation 400 that is representative of a Raman spectrum of a copper substrate, according to one or embodiments described and illustrated herein. In FIG. 4, an example x-axis 402 corresponds to a Raman shift that is measured in cm⁻¹ and ranges from 500 to 2500 and a example y-axis 404 corresponds to an intensity level and ranges from 0 to 4000 W/m². It is noted that the example graphical representation 400 is associated with a Raman spectrum that was recorded for CNTs that are covalently bonded to metal substrates. As illustrated, the example curve 406 has a peak value (e.g., peak intensity) at 1585 cm⁻¹ and may be associated with a G-band, which originates from the in-plane tangential stretching of the C—C bonds in CNTs, while the peak at 1334 cm⁻¹ may be associated with D-band.

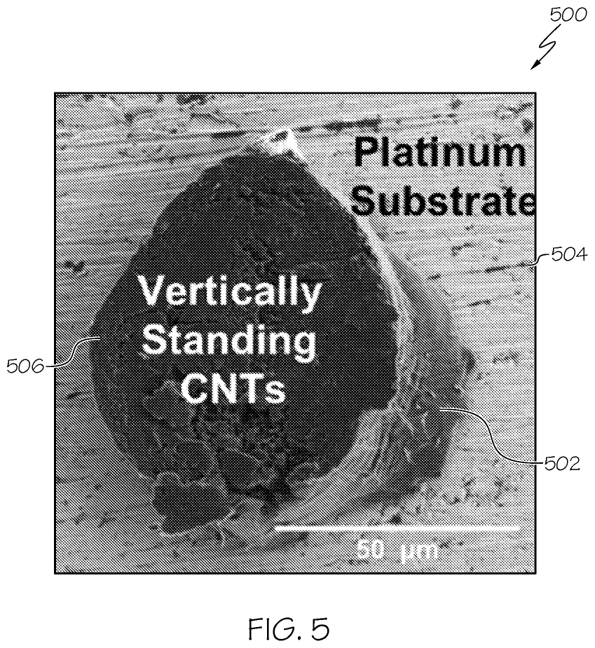

FIG. 5 depicts an SEM image of an example open-ended CNT 502 that is vertically or orthogonally oriented relative to an example substrate 504, according to one or more embodiments described and illustrated herein. It is noted that the example open-ended CNT 502 maintains its connection with the example substrate 504 (e.g., a platinum substrate) even after a removal of a polymer material in which the example open-ended CNT 502 was previously encapsulated. As such, the covalent bonding of the example open-ended CNT 502 with the example substrate 504 is strong and well maintained. Additionally, an example open end 506 of the example open-ended CNT 502 is also illustrated.

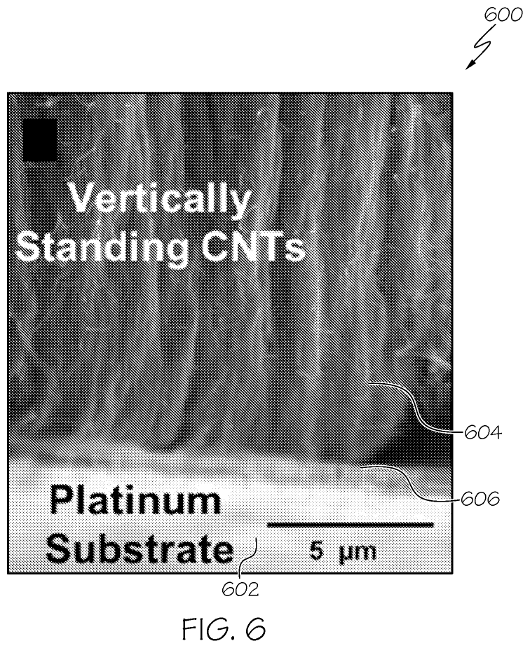

FIG. 6 depicts another SEM image 600 that is representative of the interface between an example open-ended CNT and a substrate, according to one or more embodiments described and illustrated herein. As illustrated, irrespective of the condition of the platinum substrate 602, e.g., the texture, the roughness, and other properties of the platinum substrate 602, a covalent bonding between the example open-ended CNT illustrated in FIG. 6 and the platinum substrate 602 is strong and well established, as the fibers 604 are shown to have adhered to the surface of the platinum substrate 602, and this adherence is maintained despite the fact that the surface of the platinum substrate 602 may be rough. The adherence or connection is maintained because the pressure applied to the open-ended CNT, e.g., during a reaction between amine groups and the carboxylic groups, was sufficient to strongly couple the open-ended CNT to the platinum substrate 602. It is noted that, during the covalent bonding of the open-ended CNT to the platinum substrate 602, and in particular, after the sonication of the platinum substrate 602 with the CNT, some fragments may remain on the platinum substrate 602.

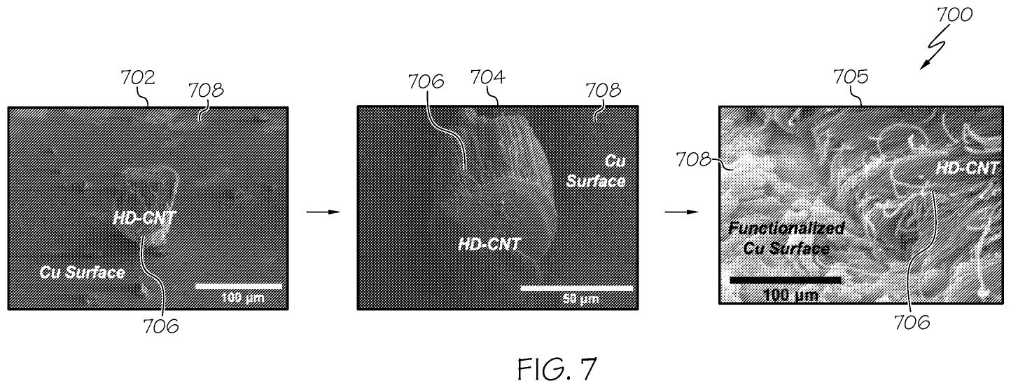

FIG. 7 depicts a plurality of three-dimensional SEM images 700 representative of the covalent bonding of an example open-ended CNT 706 with an example copper substrate 708, according to one or more embodiments described and illustrated herein. An example three-dimensional images 702, 704, and 705 illustrate the covalent bonding of the example open-ended CNT 706 with the example copper substrate 708 from various orientations and levels of magnification. The example three-dimension image 702 shows the covalent bonding of the example open-ended CNT 706 with the example copper substrate 708 from a low level of magnification after a polymer in which the example open-ended CNT 706 is encapsulated is removed. As illustrated, the covalent bonding between the two parts is strong, as the example open-ended CNT 706 maintains a vertical position such that an open-end of the CNT is positioned orthogonally relative to the example copper substrate 708 and this position is maintained.

The example three-dimensional image 704 illustrates the covalent bonding of the example open-ended CNT 706 with the example copper substrate 708 at a level of magnification that is larger than the magnification level illustrated in the example three-dimensional image 702. Additionally, the example three-dimensional image 705 illustrates the covalent bonding of the example open-ended CNT 706 with the example copper substrate 708 at a level of magnification that is larger than the magnification level illustrated in the example three-dimensional image 702 and the example three-dimensional image 704. Additionally, as illustrated in example three-dimensional image 705, the fibers of the example open-ended CNT 706 is shown to warp and adhere strongly to the fibers positioned on the example copper substrate 708.

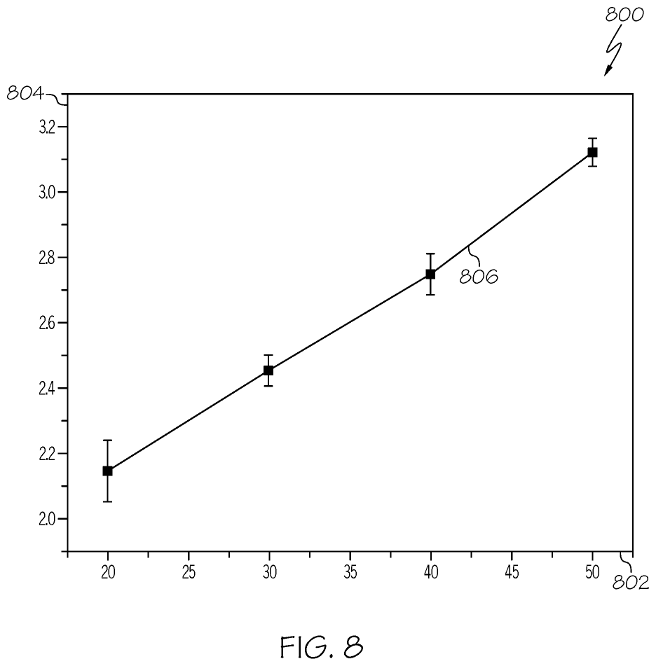

FIG. 8 depicts an example graphical representation 800 that is representative of a capability of a covalently bonded open-ended CNT to detect Pb²⁺, according to one or more embodiments described and illustrated herein. As illustrated the example graphical representation 800 includes an example x-axis 802 that corresponds to Pb²⁺ concentration levels, an example y-axis 804 that corresponds to current represented in nano amps (nA), and an example curve 806. As illustrated, the example curve 806 illustrates a linear increase in current values that are correlated with an increase in the Pb²⁺ concentration levels that range from 20 ppb to 50 ppb.

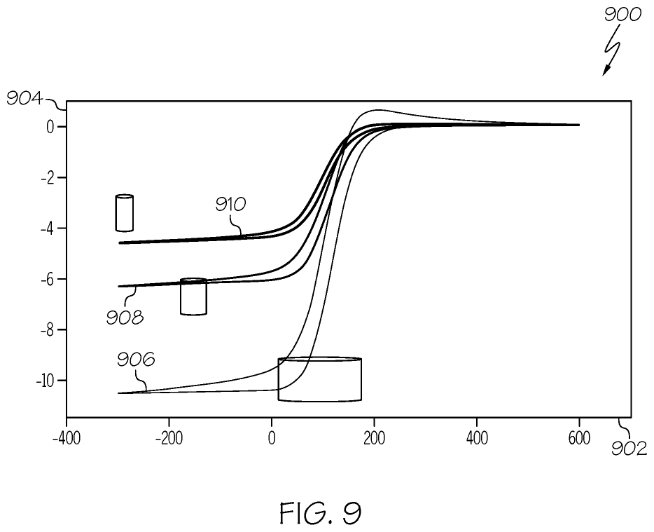

FIG. 9 depicts an example graphical representation 900 that is representative of electrical conductivity levels of an example open-ended CNT that is covalently bonded to a substrate, according to one or more embodiments described and illustrated herein. As illustrated, an example x-axis 902 corresponds to electric potential levels (e.g., voltage levels) ranging from −300 mV to 600 mV, and an example y-axis 904 corresponds to current levels ranging from −11 nA to 0.1 nA. It is noted that the data included as part of example curves 906, 908, and 910 were based on cross sections of respective open ends of a plurality of open-ended CNTs having different diameters, e.g., approximately 70 micrometers, 49 micrometers, and 28 micrometers. It is noted that, to generate the example graphical representation 900, capacitance-voltage characteristics (CV characteristics) were collected for 2 mM K3[Fe(CN)6] in 0.1 M KCl at 10 mVs-1 scan rates. As shown, the CV profile of a cross section of an open-end of an open-ended CNT having a diameter of 28 micrometers, as shown in example curve 910, is such that as electric potential varies from −300 mV to 600 mV, the current values increase from −4 nA to approximately 0 nA.

Additionally, as shown in example curves 908 and 906, the respective CV profiles of the open ends of the open-ended CNTs having diameters of 49 micrometers and 69 micrometers is such that as the electric potential varies from 300 mV to 600 mV, the current values increase from −6 nA and −11 nA respectively, to 0.1 nA. It is noted that in each of the CV profiles illustrated in FIG. 9 experience an exponential or “step like” increase when the voltage level is in a range between 0 mV and 200 mV.

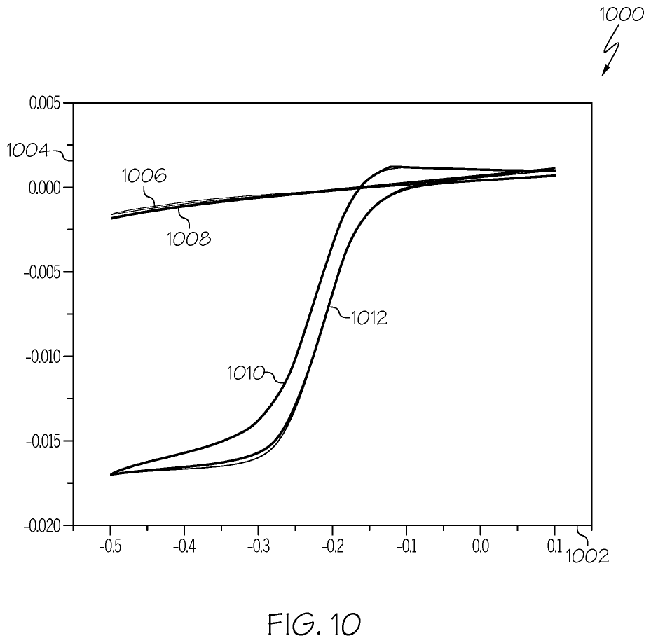

FIG. 10 depicts an example graphical representation 1000 describing an electrochemical characterization of cyclic voltammograms of open-ended CNTs that are covalently bonded to one or more substrates, according to one or more embodiments described and illustrated herein. In the example graphical representation 1000, an x-axis 1002 corresponds to electric potential (in volts) and y-axis 1004 corresponds to current (in microamps). It is noted that the example curves 1106, 1108 are representative of background noise associated with the covalently bonded open-ended CNT as a result of contact with a KCl aqueous solution, while curves 1010 and 1012 are representative of a response based on Ru(NH₃)₆^{2+/3+}. It is noted that Ru(NH₃)₆^{2+/3+} is a good indicator of the presence of carbon electrode surfaces and electrolyte interactions.

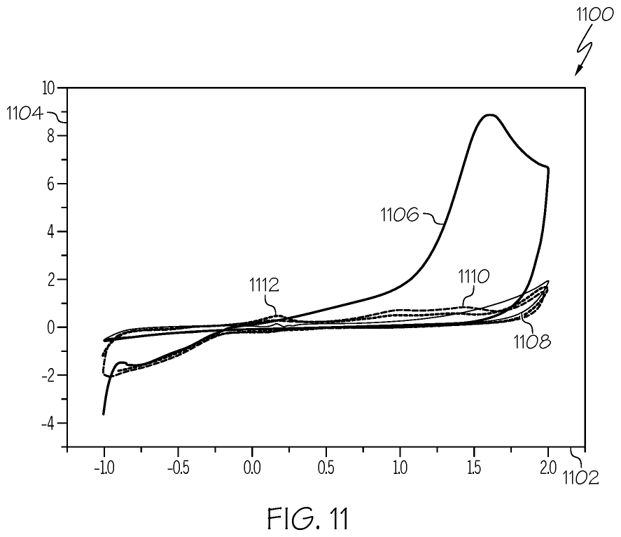

FIG. 11 depicts an example graphical representation 1100 illustrating cyclic voltammograms, according to one or more embodiments described and illustrated herein. In particular, the example graphical representation 1100 includes an x-axis 1102 that corresponds to voltage and a y-axis 1104 that corresponds to current. The cyclic voltammograms illustrated in FIG. 11 may be recorded on a standard electrode that is 1.6 millimeters in diameter. A first set of measurements that may be taken from the standard electrode are represented by example curve 1106 and a second set of measurements that may be taken by the standard electrode are represented by the example curve 1108. Additionally, it is noted that the example curve 1110 is representative of measurements associated with 0.1 M ethylenediamine in acetonitrile in combination with lithium trifluoromethanesulfonate (0.01M), which serves as a supporting electrolyte with a scan rate of 50 mV/s for the purpose of identifying ethylenediamine oxidation on the surface of the electrode, as indicated by an example curve 1112.

### Aspects Listing

Aspect 1. A method for covalently bonding vertically aligned carbon nanotubes comprises functionalizing a substrate and each open-end of a plurality of open-ended carbon nanotubes, embedding each of the plurality of open-ended carbon nanotubes within respective polymers, aligning, orthogonally, the plurality of open-ended carbon nanotubes relative to the substrate, and applying pressure on each of the plurality of open-ended carbon nanotubes relative to the substrate for enabling to the substrate for enabling covalent bonding of each of the plurality of open-ended carbon nanotubes to the substrate.

Aspect 2. The method of Aspect 1, wherein the functionalizing of the substrate comprises at least one of electrografting and radical reactions.

Aspect 3. The method of Aspect 2, wherein the electrografting including applying a potential to each of the plurality of open-ended carbon nanotubes and the substrate for the enabling of the covalent bonding.

Aspect 4. The method of Aspect 1, further comprising microtoming each of the plurality of open-ended carbon nanotubes.

Aspect 5. The method of Aspect 1, further comprising ultramicrotoming each of the plurality of open-ended carbon nanotubes, the ultramicrotoming providing each of the plurality of open-ended carbon nanotubes with a thickness in a range of 7 micrometers to 500 micrometers.

Aspect 6. The method of Aspect 1, wherein the functionalizing of each open-end of each of the plurality of open-ended carbon nanotubes is based on carboxylic functionalization.

Aspect 7. The method of Aspect 1, further comprising treating each open-end of each of the plurality of open-ended carbon nanotubes with nitric acid.

Aspect 8. The method of Aspect 1, wherein the substrate is formed of at least one of copper, aluminum, silver, titanium, tantalum, iridium, or platinum.

Aspect 9. The method of Aspect 1, wherein if the substrate is formed of copper, the functionalizing of the substrate that is formed of copper is performed using amine groups.

Aspect 10. The method of Aspect 1, wherein if the substrate is formed of platinum, the functionalizing of the substrate that is formed of platinum is performed using ethylenediamine.

Aspect 11. The method of Aspect 1, wherein the covalent bonding of each of the plurality of open-ended carbon nanotubes to the substrate occurring at a temperature in a range of 60 degrees to 250 degrees celsius.

Aspect 12. The method of Aspect 1, wherein each of the plurality of open-ended carbon nanotubes have a length in a range of 10 micrometers to 480 micrometers.

Aspect 13. The method of Aspect 1, wherein each of the polymers is clear.

Aspect 14. The method of Aspect 13, wherein the polymers are Slygard™ or Unicryl™.

Aspect 15. A method for covalently bonding vertically aligned carbon nanotubes comprises functionalizing a substrate and each open end of a plurality of high density open-ended carbon nanotubes, embedding each of the plurality of high density open-ended carbon nanotubes within respective polymers, aligning, orthogonally, the plurality of high density open-ended carbon nanotubes relative to the substrate in a forest format, and applying pressure on each of the plurality of high density open-ended carbon nanotubes relative to the substrate for enabling covalent bonding of each of the plurality of high density open-ended carbon nanotubes to the substrate.

Aspect 16. The method of aspect 15, herein the functionalizing of the substrate comprises electrografting.

Aspect 17. The method of aspect 15, further comprising microtoming each of the plurality of high density open-ended carbon nanotubes.

Aspect 18. The method of aspect 15, further comprising ultramicrotoming each of the plurality of high density open-ended carbon nanotubes, the ultramicrotoming providing each of the plurality of high density open-ended carbon nanotubes with a thickness in a range of 10 micrometers to 40 micrometers.

Aspect 19. The method of 15, wherein the substrate is formed of at least one of copper, aluminum, titanium, tantalum, or platinum.

Aspect 20. The method of 15, wherein if the substrate is formed of copper, the functionalizing of the substrate that is formed of copper is performed using amine groups.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method comprising:
functionalizing a substrate and each open-end of a plurality of open-ended carbon nanotubes;
embedding each of the plurality of open-ended carbon nanotubes within respective polymers;
aligning, orthogonally, the plurality of open-ended carbon nanotubes relative to the substrate; and
applying pressure on each of the plurality of open-ended carbon nanotubes relative to the substrate for enabling covalent bonding of each of the plurality of open-ended carbon nanotubes to the substrate.

2. The method of claim 1, wherein the functionalizing of the substrate comprises at least one of electrografting and radical reactions.

3. The method of claim 2, wherein the electrografting including applying a potential to each of the plurality of open-ended carbon nanotubes and the substrate for the enabling of the covalent bonding.

4. The method of claim 1, further comprising microtoming each of the plurality of open-ended carbon nanotubes.

5. The method of claim 1, further comprising ultramicrotoming each of the plurality of open-ended carbon nanotubes, the ultramicrotoming providing each of the plurality of open-ended carbon nanotubes with a thickness in a range of 7 micrometers to 500 micrometers.

6. The method of claim 1, wherein the functionalizing of each open-end of each of the plurality of open-ended carbon nanotubes is based on carboxylic functionalization.

7. The method of claim 1, further comprising treating each open-end of each of the plurality of open-ended carbon nanotubes with nitric acid.

8. The method of claim 1, wherein the substrate is formed of at least one of copper, aluminum, silver, titanium, tantalum, iridium, or platinum.

9. The method of claim 1, wherein if the substrate is formed of copper, the functionalizing of the substrate that is formed of copper is performed using amine groups.

10. The method of claim 1, wherein if the substrate is formed of platinum, the functionalizing of the substrate that is formed of platinum is performed using ethylenediamine.

11. The method of claim 1, wherein the covalent bonding of each of the plurality of open-ended carbon nanotubes to the substrate occurring at a temperature in a range of 60 degrees to 250 degrees Celcius.

12. The method of claim 1, wherein each of the plurality of open-ended carbon nanotubes have a length in a range of 10 micrometers to 480 micrometers.

13. The method of claim 1, wherein each of the polymers is clear.

14. The method of claim 13, wherein the polymers are Slygard™ or Unicryl™.

15. A method comprising:
functionalizing a substrate and each open end of a plurality of high density open-ended carbon nanotubes;
embedding each of the plurality of high density open-ended carbon nanotubes within respective polymers;
aligning, orthogonally, the plurality of high density open-ended carbon nanotubes relative to the substrate in a forest format; and
applying pressure on each of the plurality of high density open-ended carbon nanotubes relative to the substrate for enabling covalent bonding of each of the plurality of high density open-ended carbon nanotubes to the substrate.

16. The method of claim 15, wherein the functionalizing of the substrate comprises electrografting.

17. The method of claim 15, further comprising microtoming each of the plurality of high density open-ended carbon nanotubes.

18. The method of claim 15, further comprising ultramicrotoming each of the plurality of high density open-ended carbon nanotubes, the ultramicrotoming providing each of the plurality of high density open-ended carbon nanotubes with a thickness in a range of 10 micrometers to 40 micrometers.

19. The method of claim 15, wherein the substrate is formed of at least one of copper, aluminum, titanium, tantalum, or platinum.

20. The method of claim 15, wherein if the substrate is formed of copper, the functionalizing of the substrate that is formed of copper is performed using amine groups.
